(19) United States
(12) Patent Application Publication
(10) Pub. No.: US 2024/0020995 A1
(43) Pub. Date: Jan. 18, 2024

(54) SYSTEMS AND METHODS FOR AUTOMATED EXTRACTION OF TARGET TEXT STRINGS

(71) Applicant: ZEBRA TECHNOLOGIES CORPORATION, Lincolnshire, IL (US)

(72) Inventors: Chih Huan Chien, Buffalo Grove, IL (US); Denghui Xiao, Shanghai (CN); Yan Zhang, Buffalo Grove, IL (US); Patrick Lee Soviak, Chicago, IL (US)

(21) Appl. No.: 17/865,520

(22) Filed: Jul. 15, 2022

(51) Int. Cl. G06V 30/148; G06F 40/226

(52) U.S. Cl. CPC G06V 30/148; G06F 40/226

(57) ABSTRACT

A method of extracting a target text string includes: at a controller of a data capture device, obtaining an image of an item having the target text string thereon; at the controller, selecting a search area from the image; at the controller, processing the search area via a primary image classifier, to identify a candidate target string; at the controller, validating the candidate target string based on a validation criterion; and displaying the validated candidate target string via an output device of the data capture device.

### BACKGROUND

Items such as products in retail facilities may have a wide variety of information displayed thereon, including item identifiers, expiry dates, and the like. Handling processes in such facilities, including movement of items between storage areas and customer-facing areas, for example, may involve collecting at least some of the above information from items, e.g., for input to an inventory management system. Collection of information displayed on an item may be partially or fully automated when the information is encoded in a barcode. Some of the information, however, may be displayed in a format that is unsuitable for collection via barcode scanning, complicating the collection and processing of such information.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of an embodiment of the system of the present disclosure for automated extraction of target text strings.

FIG. 2 is a flowchart of a method for automated extraction of target text strings.

FIG. 3 is a diagram illustrating an example performance of block 205 of the method of FIG. 2.

FIG. 4 is a flowchart of a method for search area selected at block 210 of the method of FIG. 2.

FIG. 5 is a diagram illustrating an example performance of the method of FIG. 4.

FIG. 6 is a diagram illustrating an example performance of blocks 220-235 of the method of FIG. 2.

FIG. 7 is a diagram illustrating a further example performance of blocks 215-225 of the method of FIG. 2.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method of extracting a target text string, including: at a controller of a data capture device, obtaining an image of an item having the target text string thereon; at the controller, selecting a search area from the image; at the controller, processing the search area via a primary image classifier, to identify a candidate target string; at the controller, validating the candidate target string based on a validation criterion; and displaying the validated candidate target string via an output device of the data capture device.

Additional examples disclosed herein are directed to a computing device, comprising: a camera; and a controller configured to: obtain, via the camera, an image of an item having the target text string thereon; select a search area from the image; process the search area via a primary image classifier, to identify a candidate target string; validate the candidate target string based on a validation criterion; and display the validated candidate target string via an output device of the data capture device.

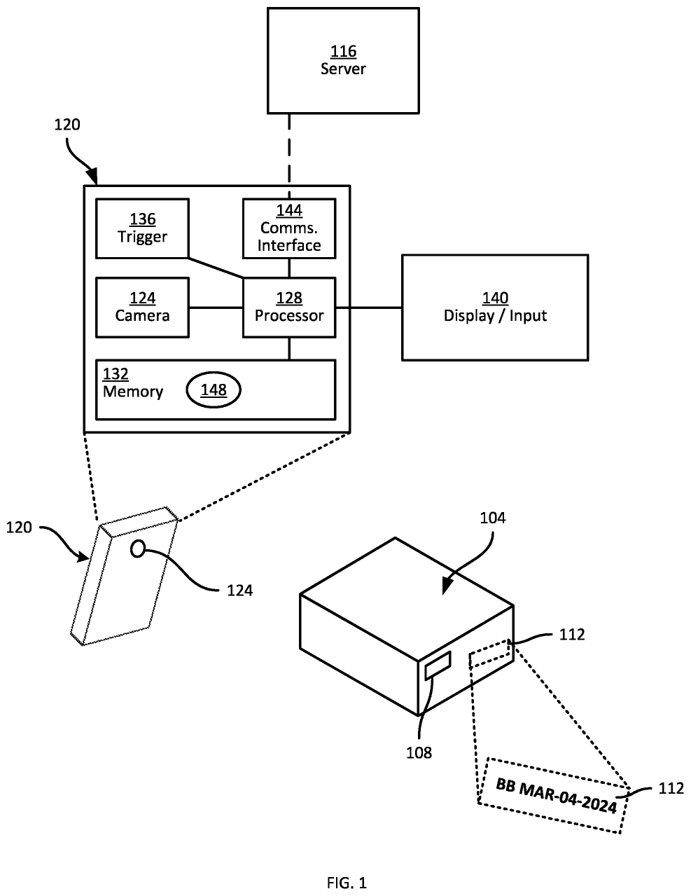

FIG. 1 illustrates a system 100 for automated or partially automated extraction of target text strings, e.g., displayed on an item 104 such as a retail product, or the like. The item 104 may be, for example, a dry goods product available for purchase at a retail facility such as a grocery store. In the illustrated example, the item 104 includes a barcode or other machine-readable indicium 108 (e.g., a two-dimensional (2D) barcode, a radio frequency identification (RFID) tag, or the like). The indicium 108 can be displayed on a label affixed to the item 104, or integrated with packaging graphics of the item 104 (that is, printed or otherwise affixed to the item 104 along with branding and other indicia). The indicium 108 encodes a product identifier, such as a Universal Product Code (UPC), which uniquely identifies items of the same type as the item 104, though not necessarily the illustrated instance of the item 104 from other items of the same type.

The item 104 can include various other information displayed on exterior surfaces thereof, including but not limited to, in the illustrated example, an expiry date 112 (also referred to as a best-before date, or the like). In contrast with the above-mentioned item identifier, the expiry date 112 is not encoded in a machine-readable indicium, but is instead displayed on the item 104 as a text string. A wide variety of other information can also be displayed on the item 104 in text strings, in addition to or instead of the expiry date 112. Examples of such information include lot and/or batch identifiers, production dates, product weights, and the like.

Various handling operations in the facility containing the system 100 (e.g., the above-mentioned grocer) involve collecting at least a portion of the above-mentioned information. For example, when a number of instances of a given item type are received at the facility, some of those instances may be placed in storage, e.g., in a back room inaccessible to customers of the facility, while other instances may be allocated for display in a customer-facing area of the facility. The determination of which area to allocate a given item to may be based in part on the expiry date displayed on that item 104. In the illustrated example, the system 100 includes a server 116 implementing inventory management functionality. Provision of an item identifier and corresponding expiry date to the server 116 enables the server 116 to store that information in a repository, and may also enable the server 116 to generate handling instructions for the item 104 (e.g., indicating a storage location for the item 104). A wide variety of other handling operations may also depend in part on information displayed in text form on the item 104.

Text-based information on the item 104 may, however, be less amenable to automated collection than the product identifier encoded in the indicium 108. While a barcode scanning device can be deployed to readily decode the indicium 108 and determine the product identifier, machine-implemented extraction of a particular target string of text (e.g., the expiry date 112) from the item 104 may be complicated by various factors. For example, information such as the expiry date 112 may be applied to the item 104 separately from the above-mentioned packaging graphics and the like, such that the position of the expiry date 112 on the item 104 is inconsistent between instances of the same item type. Further, some optical character recognition mechanisms may fail to distinguish the expiry date 112 from other, non-target, text strings displayed on the item 104. Still further, the format of the expiry date 112 may vary from one item 104 to another. In the illustrated example, the expiry date “Mar. 4, 2024” is preceded by an associated string “BB” (i.e., “best before”). In other examples, however, other associated strings may appear instead of “BB”, e.g., “Best if used by”, “BEST BEFORE”, and so on. The date itself may also appear in a variety of formats, e.g., with the month component represented numerically rather than with letters, with a different order of the day, month, and year components, and the like.

The system 100 therefore includes certain components and implements certain functionality, discussed in greater detail below, to enable the machine-implemented extraction of text-based information such as the expiry date 112.

In particular, the system 100 includes a data capture device 120. The data capture device 120 can be implemented as a fixed device, e.g., disposed in a receiving dock of the facility or the like, or as a mobile device, such as a tablet computer, smart phone, mobile computer, or the like. The data capture device 120, also referred to herein as the device 120, is configured to capture one or more images of the item 104, with the item 104 positioned such that the expiry date 112 is in a field of view of a camera 124 of the device 120. The device 120 is further configured to process captured images to identify specific target text strings, such as the expiry date 112, and to display the extracted target string(s), e.g., to the server 116 for further processing. The camera 124 can include any suitable image sensor or set of image sensors. In other examples, the device 120 can include a distinct barcode scanning assembly (not shown). As will be discussed below, the camera 124 can also be employed for barcode capture.

Certain internal components of the device 120 are shown in FIG. 1, in addition to the camera 124. In particular, the device 120 includes a controller, also referred to as a processor 128 (e.g., a central processing unit, graphics processing unit, or combination thereof), in communication with a non-transitory computer readable storage medium, such as a memory 132. The memory 132 includes a combination of volatile memory (e.g., Random Access Memory or RAM) and non-volatile memory (e.g., read only memory or ROM, Electrically Erasable Programmable Read Only Memory or EEPROM, flash memory). The processor 128 and the memory 132 each comprise one or more integrated circuits.

The device 120 can also include at least one input device, such as a trigger 136 (e.g., a physical button in some examples) in communication with the processor 128 and configured to initiate an image capture operation upon activation. In other examples, the trigger 136 can be omitted, and the device 120 can capture a continuous image stream rather than performing discrete operator-initiated image capture operations. The processor 128 can also, as in the illustrated example, be connected with an externally-housed (e.g., in a separate physical housing than the device 120, although communicatively coupled with the processor 128) display 140, which can include an integrated touch panel. In other examples, a distinct input device such as a keypad can be deployed alongside the display 140. The processor 128 can control the display 140 to present various information to an operator, and can receive input from the operator via the touch panel. In further examples, the display 140 and touch panel can be integrated with the device 120, in a common housing. The device 120 can also include other input and/or output assemblies, such as a microphone, a speaker, an indicator light, and the like.

The device 120 further includes a communications interface 144 in communication with the processor 128. The communications interface 144 includes any suitable hardware (e.g., transmitters, receivers, network interface controllers and the like) allowing the device 120 to communicate with other computing devices, such as the server 116, via wired and/or wireless links (e.g., over local or wide-area networks).

The memory 132 stores computer readable instructions for execution by the processor 128. In particular, in the illustrated example the memory 132 stores a text extraction application 148 which, when executed by the processor 128, configures the processor 128 to perform various functions discussed below in greater detail and related to the capture of images of items and automated extraction of target text strings therefrom. The application 148 may also be implemented as a suite of distinct applications in other examples. Those skilled in the art will appreciate that the functionality implemented by the processor 128 via the execution of the application 148 may also be implemented by one or more specially designed hardware and firmware components, such as field-programmable gate arrays (FPGAs), application-specific integrated circuits (ASICs) and the like in other embodiments.

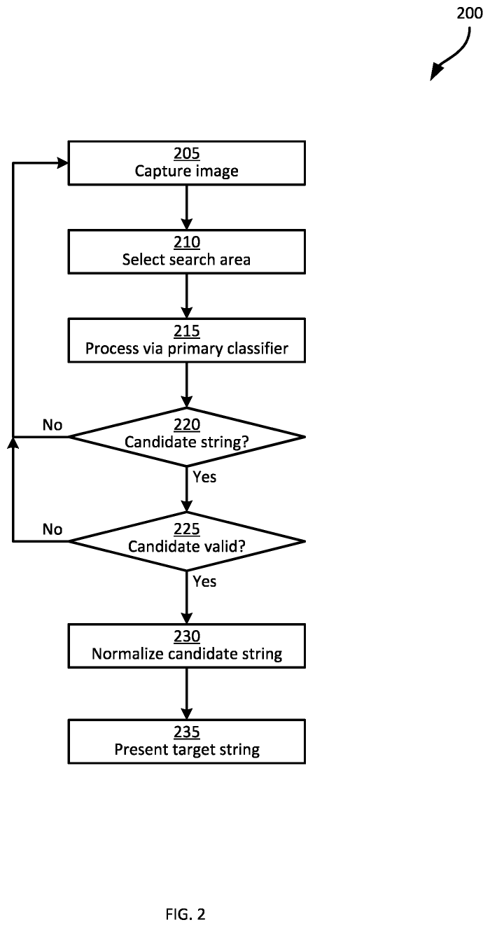

Turning to FIG. 2, a method 200 of target text string extraction is shown. The method 200 will be described in conjunction with its performance by the device 120. In some examples, however, the server 116 can perform some of the blocks described as being performed by the device 120.

At block 205, the data capture device 120 is configured to obtain an image of the item 104, depicting the target text string (e.g., the expiry date 112, in this example). For example, the processor 128 can be configured via execution of the application 148 to detect an activation of the trigger 136 and, in response, to control the camera 124 to capture an image. In other examples, the processor 128 can control the camera 124 to continuously capture images, without requiring activation of the trigger 136 for each capture.

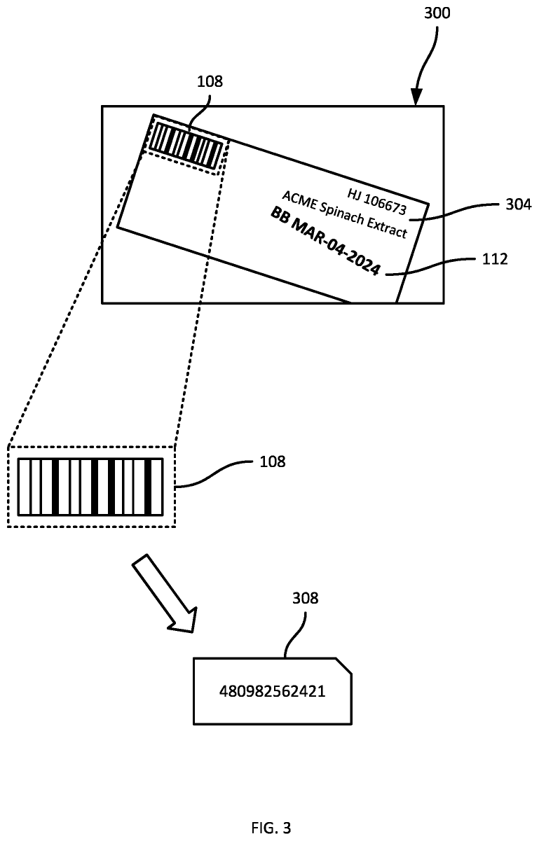

As will be apparent to those skilled in the art, the processor 128 can also be configured to detect and decode the machine-readable indicium 108 in the captured image. For example, referring to FIG. 3, an image 300 of the item 104 captured by the camera 124 is illustrated, in which the indicium 108, the expiry date 112, and one or more non-target text strings 304 are displayed. From the image 300, the processor 128 can be configured to detect and decode the indicium 108 to obtain a product identifier 308, such as a UPC as mentioned earlier. In other examples, the product identifier 308 need not be obtained from the image 300, and can be obtained in a separate scanning operation (e.g., performed by a scanner distinct from the device 120).

Returning to FIG. 3, at block 210 the processor 128 is configured to select a search area from the image captured at block 205. The search area can, in some examples, include the entire image 300. In some examples, the accuracy of expiry date extraction can be improved, and/or the computational load on the processor 128 by extraction of the expiry date 112 can be mitigated, by selecting a search area that is smaller than the entire image 300, and is likely to contain the expiry date 112. In general, the processor 128 can be configured to select the search area at block 210 by processing the image 300 to detect an associated string (e.g., the string “BB” in the illustrated example). As discussed further below, a primary classifier processes the selected search area to extract the expiry date 112.

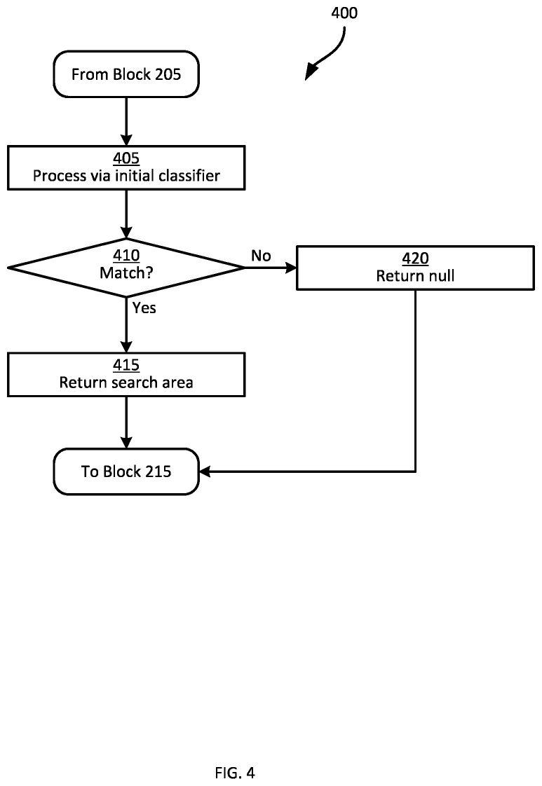

Turning to FIG. 4, an example method 400 for implementing block 210 is illustrated. At block 405, the processor 128 is configured to process the image via an initial classifier to identify a string associated with the target string. In the present example, where the target string is the expiry date 112, the initial classifier is configured to search the image 300 for any instances of a predetermined set of associated strings, such as “BEST IF USED BY”, “BB”, “SELL BY”, “BEST”, “BY”, “EXP”, “SELL-BY-DATE”, “BETTER IF USED BY”, and the like. The initial classifier can be a deep learning algorithm or set of such algorithms. For example, the initial classifier can be implemented as a Convolutional Recurrent Neural Network (CRNN), trained with a library of labelled images of the above-mentioned associated strings. In other words, the initial classifier implements an optical character recognition mechanism that is sensitive to the associated strings. In other examples, the initial classifier can implement generic text recognition, followed by a filter to determine whether any of the detected text matches the above-mentioned associated strings.

At block 410, the processor 128 is configured to determine whether any portion of the image 300 matches a predetermined associated string. When one or more associated strings are detected, the determination at block 410 is affirmative, and the initial classifier returns one or more search areas based on the detected associated strings. When the determination at block 410 is negative, indicating that no associated strings are detected, the initial classifier returns a null result at block 420, and the processor 128 is configured to proceed with the performance of the method 200 (at block 215) by processing the entire image 300.

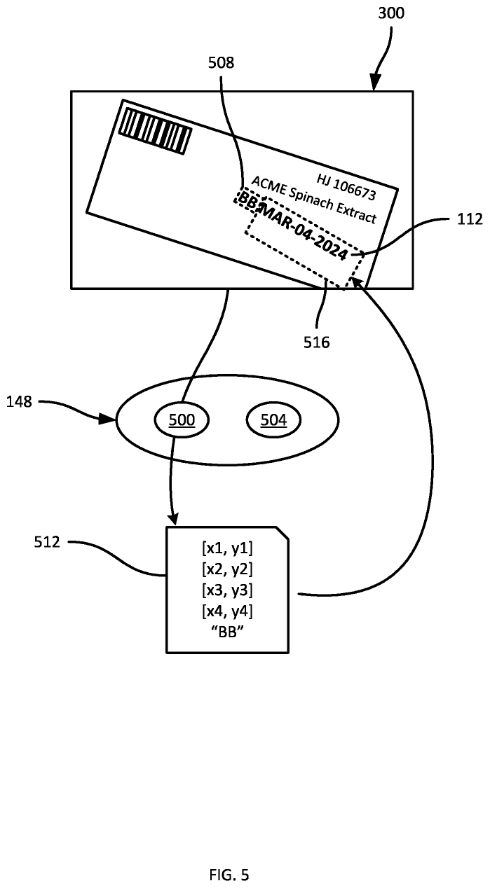

FIG. 5 illustrates an example performance of the method 400. In particular, the application 148 is illustrated as implementing two distinct classifiers, including an initial classifier 500 and a primary classifier 504. The initial classifier 500, as mentioned above, is trained to detect specific associated strings that indicate the likely presence of an expiry date 112. The primary classifier 504, in contrast, is trained to detect expiry dates themselves (or any other suitable target string). At block 405, therefore, the image 300 is processed via the initial classifier 500, to detect any instances of associated strings. As shown in FIG. 5, the initial classifier 500 detects an associated string 508, and generates a detection record 512 containing a location of the associated string 508, and the string itself. The record 512 can contain, for example, pixel coordinates of a bounding box surrounding the detected associated string (illustrated as four pairs of X and Y coordinates in FIG. 5), as well as the string.

Following an affirmative determination at block 410, the processor 128 generates a search area at block 415, based on the location of the associated string. As shown in FIG. 5, the processor 128 can generate a search area 516 based on the location and/or size of the bounding box mentioned above. For example, since expiry dates 112 frequently appear to the right and/or below the associated string, the processor 128 can generate the search area 516 as a bounding box extending rightwards (according to the orientation of the associated string 508) and downwards. The extents of the search area 516 can be fixed, e.g., as predetermined numbers of pixels rightward and downward from a location of the associated string 508, or as predetermined fractions of the image rightward and downward from the location of the associated string 508. In other examples, the search area 516 can be determined dynamically, based on the dimensions of the associated string 508. For example, the search area 516 can extend four times the width of the associated string 508 to the right, and twice the height of the associated string 508 downwards. A wide variety of other mechanisms for generating the search area 516 will be evident to those skilled in the art, reflecting the principle that the target string is expected to appear adjacent to the associated string 508. In some examples, the location and size of the search area can be determined by which specific associated string was detected. That is, the application 148 can define search area attributes specific to each associated string for which the initial classifier 500 is trained (e.g., specifying a search area extending to the right of the associated string “BB”, and a search area immediately below the associated string “BEST BEFORE”).

As noted above, at block 415 the search area 516 is returned as an output of the method 400, for further processing via execution of the application 148. Returning to FIG. 3, at block 215 the processor 128 is configured to process the search area (e.g., the search area 516, or the entire image 300) via the primary classifier 504 to identify one or more candidate target strings. The primary classifier 504 can be, for example, a second CRNN trained with a labelled set of images of expiry dates, e.g., collected from items such as the item 104. In other words, the primary classifier 504 can implement an optical character recognition mechanism that is sensitive to the target strings specifically, rather than to text more generally.

At block 220, the processor 128 is configured to determine whether the primary classifier 504 identifies one or more candidate strings, likely to correspond to the target string (e.g., the expiry date 112, in this example). The determination at block 220 can also be based on a confidence level generated by the primary classifier 504 in association with any detected candidate strings. For example, if one candidate string is detected, but the confidence level associated with the candidate string is below a threshold (e.g., 50%, although various other thresholds can also be used), the determination at block 220 is negative, as it would be if no candidate strings were detected at all). When more than one search area is selected at block 210, block 220 can be repeated for each search area.

When the determination at block 220 is negative, the processor 128 can return to block 205 to capture another image. The processor 128 can await another activation of the trigger 136, for example. When the camera 124 is controlled to capture images continuously, the next image from the continuous stream is selected at block 205. For either or both image capture modes, the processor 128 can control an output device, such as the display 140, an indicator light, a speaker, or the like, to notify an operator of the device 120 that target string extraction was unsuccessful, and prompt the operator to reposition the item 104 in the field of view of the camera 124.

When the determination at block 220 is affirmative, indicating that at least one candidate string is identified in the search area from block 210 (that is, at least one text string that is likely to be an expiry date, in this example), the processor 128 proceeds to block 225. At block 225, the processor 128 is configured to determine whether the candidate string is valid, based on at least one validation criterion. The determination at block 225 is repeated for each candidate string identified at block 220.

The validation criteria applied at block 225 serve to determine whether the candidate string, which was sufficiently similar to an expiry date to be identified by the primary classifier 504, is in fact an expiry date. For example, the validation criteria can include an expected range for at least one date component. The processor 128 can be configured to identify components of the candidate string according to predetermined formatting rules. For example, a four-digit number in the candidate string can be a year component. Further, a two-digit number in the candidate string can be either a month component or a day component. If the candidate string also contains a three-character (non-numerical) string, that can be a month component.

An example validation criterion is an expected range for a year component of the candidate string. The year range may extend, for example, from a current year to a predetermined number of years in the future (e.g., five years, although a wide variety of other values can also be used). Such a criterion reflects an assumption that the items being scanned are highly unlikely to have expiry dates more than five years in the future. Therefore, a candidate string that includes a year component more than five years in the future is unlikely to be a date. Various other examples of validation criteria will also be evident to those skilled in the art. For example, a two-digit number (which may be either a day component or a month component) exceeding a value of thirty-one indicates that the candidate string is unlikely to represent a date. As a further example, if the candidate string includes a pair of two-digit numbers (one being a month component and the other being a day component), validation fails if both numbers exceed a value of twelve.

If no candidate string satisfies the validation criteria, the processor 128 returns to block 205, optionally generating a notification and/or prompt as discussed above in connection with block 220. When a candidate string satisfies the validation criteria, the processor 128 proceeds to block 230. In some implementations, the processor 128 can apply one or more corrections to the candidate string, e.g., after an affirmative determination at block 225 and prior to the performance of block 230. The application 148 can include, for at least one month (where the target string is a date), a list of variants that can result from optical character recognition errors, along with a reference value for that month. The processor 128 can determine whether the candidate string contains any of the variants, and replace a detected variant with the reference value. For example, the application 148 can include the variant “ARR” for the month of April, along with the reference string “APR”. Upon detecting the string “ARR” in the candidate string, the processor 128 can therefore replace the string “ARR” with the reference string “APR”.

At block 230, the processor 128 can be configured to normalize the validated candidate string, e.g., if the server 116 requires that expiry dates be provided in a predefined format. In other examples, block 230 can be omitted. Normalization can include arranging the components of the target string (e.g., day, month, and year components) in a predefined order. Normalization can also include replacing components with predetermined reference values, e.g., to represent the month component with a two-digit number rather than a three-character string.

Following block 230, or following an affirmative determination at block 225 if block 230 is omitted, the device 120 is configured to present the extracted target string, e.g., on the display 140. Presenting the target string can also include generating and sending a message to the server 116 including the target string, and optionally the previously mentioned product identifier obtained from the indicium 108. Following the performance of block 235, the processor 128 can present a notification to scan the next item, e.g., via the display 140 or another suitable output device.

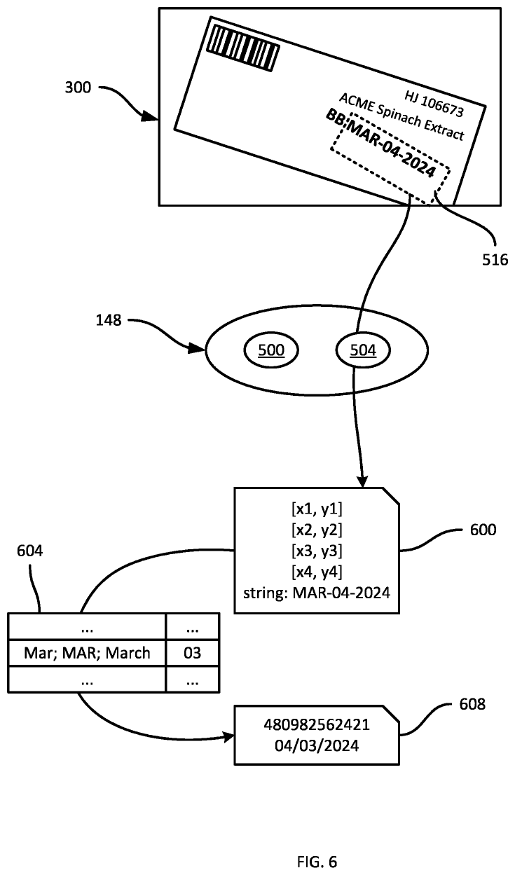

FIG. 6. illustrates an example performance of blocks 215 to 235. In particular, at block 215 the search area 516 is extracted from the image 300 and processed via the primary classifier 504. The primary classifier 504 identifies the string “Mar. 4, 2024” from the search area 516, and the determination at block 220 is therefore affirmative. The output of candidate string detection is illustrated as a record 600 including the candidate string itself, as well as a set of X and Y value pairs indicating the corners of a bounding box within the search area 516 corresponding to the candidate string.

The determination at block 225 is also assumed to be affirmative, e.g., because the year component “2024” of the candidate string is less than five years in the future relative to a current year (2022). At block 230, the candidate string can be normalized, according to a repository 604 of normalized component values. As seen in FIG. 6, the repository 604 includes, for each month component, a normalized value and a corresponding set of candidate string values. Each candidate string value in the candidate string is replaced with the corresponding normalized value. The repository 604 can also specify a component order for the normalized string. Thus, in the illustrated example, the month component “MAR” is replaced with the normalized value “03”, and the order of the day and month components is reversed. The resulting normalized target string “Apr. 3, 2024” can be included in a message 608, e.g., for transmission to the server 116 at block 235.

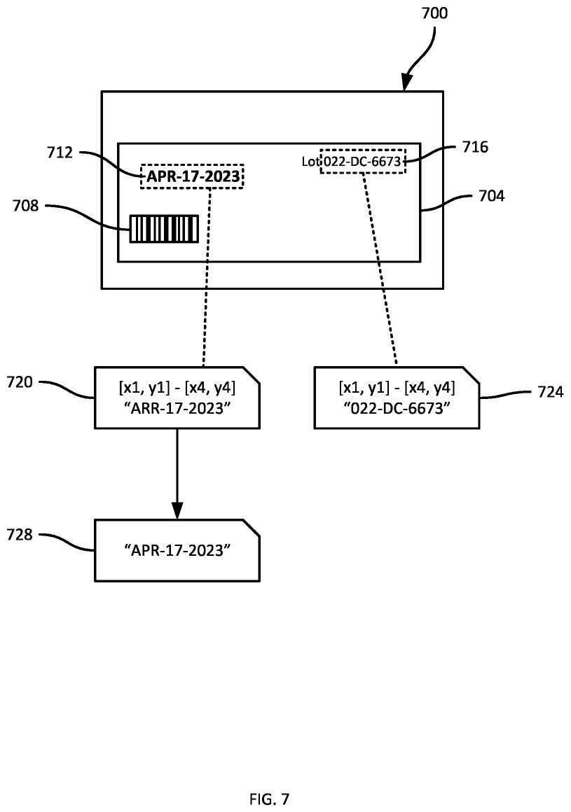

FIG. 7 illustrates another example image 700 depicting a further item 704 bearing a machine-readable indicium 708, an expiry date 712, and a non-target string 716. As shown in FIG. 7, the expiry date 712 is not accompanied by an associated string, and at block 210, the entire image 700 is therefore selected as a search area (e.g., the determination at block 410 is negative). Further, the non-target string 716, although not an expiry date, includes the text “022-DC-6673” that sufficiently resembles a date that at block 215, two records 720 and 724 are generated.

At block 225, the record 720 is validated, but the record 724 is not validated, because the four-digit number “6673” (which resembles a year component of an expiry date) falls outside the previously-mentioned range. The record 724 can therefore be discarded. The candidate string in the record 720, meanwhile, can be corrected as noted above, to replace the characters “ARR” (having been incorrectly detected from the image 700) with the characters “APR” in a corrected candidate string 728. The string 728 can then be normalized as described above at block 230.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method of extracting a target text string, comprising:
at a controller of a data capture device, obtaining an image of an item having the target text string thereon;
at the controller, selecting a search area from the image;
at the controller, processing the search area via a primary image classifier, to identify a candidate target string;
at the controller, validating the candidate target string based on a validation criterion; and
displaying the validated candidate target string via an output device of the data capture device.

2. The method of claim 1, wherein selecting the search area includes processing the image via an initial classifier to identify an associated text string.

3. The method of claim 2, wherein selection of the search area is based on a location of the associated text string.

4. The method of claim 1, wherein the displaying includes transmitting a message to a server, the message containing the validated candidate target string.

5. The method of claim 4, further comprising, prior to transmitting the message, normalizing the candidate target string.

6. The method of claim 5, wherein normalizing the candidate target string includes:
storing a repository containing (i) a set of candidate values corresponding to a target string component, and (ii) a corresponding normalized value for the target string component;
identifying one of the candidate values in the candidate target string; and
replacing the identified value with the normalized value from the repository.

7. The method of claim 1, further comprising:
detecting a machine-readable indicium from the image;
decoding an item identifier from the machine-readable indicium; and
displaying the item identifier with the validated candidate target string.

8. The method of claim 1, wherein the target text string represents a date;
wherein the validation criterion includes an expected range corresponding to a date component; and
wherein validating the candidate target string includes determining whether a candidate component of the candidate target string falls within the range.

9. The method of claim 8, wherein the date components include a year, a month, and a day.

10. The method of claim 9, wherein the range is defined by a current year and a predetermined number of years after the current year.

11. A computing device, comprising:
a camera; and
a controller configured to:
obtain, via the camera, an image of an item having a target text string displayed thereon;
select a search area from the image;
process the search area via a primary image classifier, to identify a candidate target string;
validate the candidate target string based on a validation criterion; and
display the validated candidate target string via an output device of the data capture device.

12. The computing device of claim 11, wherein the controller is configured to select the search area by processing the image via an initial classifier to identify an associated text string.

13. The computing device of claim 12, wherein selection of the search area is based on a location of the associated text string.

14. The computing device of claim 11, wherein the controller is configured to display the validated candidate target string by transmitting a message to a server, the message containing the validated candidate target string.

15. The computing device of claim 14, wherein the controller is further configured to, prior to transmitting the message, normalize the candidate target string.

16. The computing device of claim 15, wherein controller is further configured, to normalize the candidate target string, to:
store a repository containing (i) a set of candidate values corresponding to a target string component, and (ii) a corresponding normalized value for the target string component;
identify one of the candidate values in the candidate target string; and
replace the identified value with the normalized value from the repository.

17. The computing device of claim 11, wherein the controller is further configured to:
detect a machine-readable indicium from the image;
decode an item identifier from the machine-readable indicium; and
display the item identifier with the validated candidate target string.

18. The computing device of claim 11, wherein the target text string represents a date;
wherein the validation criterion includes an expected range corresponding to a date component; and
wherein the controller is configured, to validate the candidate target string, to determine whether a candidate component of the candidate target string falls within the range.

19. The computing device of claim 18, wherein the date components include a year, a month, and a day.

20. The computing device of claim 19, wherein the range is defined by a current year and a predefined number of years after the current year.
